(19) United States
(12) Patent Application Publication
(10) Pub. No.: US 2010/0089801 A1
(43) Pub. Date: Apr. 15, 2010

(54) PROCESS FOR PRODUCTION OF LOW-SPECIFIC-GRAVITY HOLLOW PARTICLES

(75) Inventors: Takashi Ando, Sodegaura-Shi (JP); Tsuyoshi Hirajima, Fukuoka-shi (JP); Moriyasu Nonaka, Fukuoka-shi (JP); Yuji Osako, Fukuoka-shi (JP)

Correspondence Address: DARBY & DARBY P.C., P.O. BOX 770, Church Street Station, New York, NY, 10008-0770, US

(73) Assignees: IDEMITSU KOSAN CO., LTD., Tokyo (JP); KYUSHU UNIVERSITY, Fukuoka (JP); JAPAN COAL ENERGY CENTER, Tokyo (JP)

(21) Appl. No.: 12/599,001

(22) PCT Filed: May 1, 2008
(86) PCT No.: PCT/JP2008/058386

§ 371 Date: Nov. 5, 2009

(30) Foreign Application Priority Data
May 8, 2007 (JP) 2007-123718

(51) Int. Cl. B09B 5/00; B03B 7/00

(52) U.S. Cl. 209/3.1

(57) ABSTRACT

To enable high-added-value low-specific-gravity hollow particles to be efficiently mass-produced by using, as a raw material, coal ash discharged when coal is combusted; enriching low-specific-gravity hollow particles contained in the raw material coal ash by classification to reduce the weight of the coal ash to be subjected to wet specific gravity separation; subjecting the raw material coal ash which have been reduced in weight to wet specific gravity separation to obtain low-specific-gravity components; and dehydrating and drying the low-specific-gravity components.

### TECHNICAL FIELD

The invention relates to a method for producing low-specific-gravity hollow particles for mass producing high-added-value low-specific-gravity hollow particles efficiently by using, as a raw material, coal ash generated when powdered coal is combusted.

### BACKGROUND ART

Coal ash generated when finely-pulverized coal (powdered coal) is combusted in a coal-fired power plant or the like is one of industrial wastes. In Japan, conventionally, not less than 80% of coal ash has been collected as fly ash, and an attempt has been made on the effective use of the collected fly ash.

The collected fly ash is used mainly as a substitute for clay for producing cement, and the part thereof is used as a cement admixture, or the like. In recent years, in order to study the effective application of fly ash to a field other than cement raw materials, low-specific-gravity hollow particles contained in fly ash has attracted attention. Such hollow particles are called cenospheres, which are spherical hollow particles composed mainly of silica and alumina which exist in fly ash in a very small quantity. They have a high strength, have a low specific gravity (specific gravity: 1 or less) due to their hollow structures, and are excellent in thermal insulation. Therefore, the use thereof as heat-insulating ceramic materials in a field such as building materials is expected.

Cenospheres contained in fly ash float on water since they have a low specific gravity. Therefore, generally, fly ash can be produced by collecting particles which have come up to the water surface of an ash-discharging pond where fly ash is abandoned.

However, in Australia, the U.S., China, Russia or other countries, although cenospheres were already produced by such a method and put on the market, the production thereof was unstable. Further, in Japan where environmental regulations are strict, it is difficult to adopt such a production method. Therefore, production of cenospheres on the industrial scale was not conventionally performed in Japan.

The production amount of coal ash has been increasing year by year. It is expected that the production amount of coal ash will be increased also in the future. Under such circumstances, development of a technology of producing high-added-value cenospheres on the industrial scale is of crucial importance. For example, U.S. Pat. No. 5,047,145 discloses a method for producing cenospheres from fly ash by the wet specific gravity separation method.

Specifically, in U.S. Pat. No. 5,047,145, cenospheres are produced by the following method. Fly ash, as a raw material, is mixed with a liquid such as water to form slurry. Since particles having a lower specific gravity than that of a liquid come up to the surface of the slurry, only the particles which come up to the slurry surface (cenospheres) are collected by skimming or the like, followed by dehydration and drying, whereby cenospheres are produced.

Meanwhile, non-cenosphere particles other than cenospheres, which sink in the liquid, can be used as fly ash in a cement admixture or the like after conducting dehydration and drying separately.

### DISCLOSURE OF THE INVENTION

### Problems to be Solved by the Invention

The amount of cenospheres contained in fly ash is very small, which is usually about 1% (or less than 1%). Therefore, according to the wet specific gravity separation method disclosed in U.S. Pat. No. 5,047,145, in order to produce 1,000 tons of cenosphere, 100,000 tons or more, which is 100 times larger than 1,000 tons, of fly ash must be treated by a wet method, for example. Therefore, it was difficult to produce a large amount of cenospheres on the industrial scale, since large-sized equipment and a huge amount of energy are required for dehydration and drying.

If specific gravity separation can be carried out also by a dry method, dehydration and drying will become unnecessary. However, such a technology has not yet been completed.

In view of the above-mentioned circumstances, the inventors made intensive studies. As a result, the inventors have found that, before carrying out specific gravity separation of a large amount of fly ash by a wet method, by enriching by a simple method cenospheres contained in the fly ash to be treated to reduce the weight of the fly ash, and by subjecting the fly ash to wet specific gravity separation, a wet specific gravity separation apparatus for producing the same quantity of cenospheres can be smaller in size and energy required for dehydration and drying can be reduced.

The invention has been made on this finding, and the invention provides a method for mass-producing high-added-value low-specific-gravity particles (cenospheres) efficiently by using coal ash which is generated when powdered coal is burned.

### Means for Solving the Problems

The method for producing low-specific-gravity hollow particles according to the invention comprises: using, as a raw material, coal ash which is discharged when coal is combusted;

subjecting the coal ash to classification by sieving or dry classification at a prescribed particle size; subjecting the classified coarse particle matters to wet specific gravity separation to obtain low-specific-gravity components; and
dehydrating and drying the low-specific-gravity components.

According to the method for producing low-specific-gravity hollow particles of the invention, by classifying coal ash to be used as a raw material, low-specific-gravity hollow particles contained in the coal ash can be enriched, whereby the weight of fly ash which is to be subjected to wet specific gravity separation can be significantly reduced. As a result, an increase in size of a wet gravity separation apparatus or an increase in energy required for dehydration and drying can be effectively avoided, and high-added-value low-gravity-hollow particles can be mass-produced efficiently using coal ash generated when powdered coal is burned.

In the method for producing low-specific-gravity hollow particles according to the invention, the coal ash is preferably fly ash which has been collected from a combustion gas discharged from a pulverized coal-fired boiler. In particular, it is preferred that the coal ash be the JIS Type-IV fly ash.

In the method for producing low-specific-gravity hollow particles of the invention, in enriching low-specific-gravity hollow particles by classifying coal ash, it is possible to set optimum particle size conditions for collecting low-specific-gravity hollow particles efficiently with a small degree of loss by studying the particle size distribution of the coal ash as a raw material, the amount ratio of low-specific-gravity hollow particles or the like. The above-mentioned coarse particle matters to be subjected to wet specific gravity separation may be coarse particle matters which are obtained by subjecting the above-mentioned coal ash to classification by sieving or dry classification at a particle size of 20 μm or more.

In the method for producing low-specific-gravity hollow particles according to the invention, classification of coal ash to be used as a raw material may be performed plurality of times at different particle sizes. Specifically, the above-mentioned coarse particle matters to be subjected to wet specific gravity separation may be second coarse particle matters obtained by further subjecting fine particle matters which are obtained by subjecting said coal ash to classification by sieving or dry classification at a particle size of 20 μm or more to classification by sieving or dry classification at a particle size of 5 to 20 μm.

### ADVANTAGEOUS EFFECTS OF THE INVENTION

As mentioned above, according to the invention, by classifying coal ash as a raw material, it is possible to enrich low-specific-gravity hollow particles contained in the coal ash, thereby to significantly reduce the amount of fly ash to be subjected to wet specific gravity separation, whereby high-added-value low-specific-gravity hollow particles can be efficiently mass produced.

### BEST MODE FOR CARRYING OUT THE INVENTION

A preferred embodiment of the invention will be explained hereinbelow.

In this embodiment, low-gravity-hollow particles are produced by using as a raw material coal ash which is generated when pulverized coal (powdered coal) is combusted in coal-fired power plants or the like, preferably fly ash which is collected from a combustion gas from a pulverized coal-fired boiler through a dust catcher, or the like.

Fly ash is a material which is obtained by collecting ash particles generated by the combustion of powdered coal, floats in a high-temperature combustion gas in the molten state, coagulates at the outlet of a boiler and is collected in a dust catcher, or the like. Fly ash contains a small amount (about 1%, or less than 1%) of low-specific-gravity hollow particles (cenosphere) which are formed into hollow particles during the process of coagulation. In this embodiment, cenospheres, which are low-specific-gravity hollow particles, are produced by collecting them from fly ash at a high efficiency.

As mentioned above, if an attempt is made to collect cenospheres in fly ash by wet specific gravity separation, a large amount of fly ash must be treated. As a result, an increase in size of an apparatus is inevitably required, and a huge amount of energy is necessary in dehydration and drying. Therefore, in this embodiment, cenospheres contained in fly ash are enriched to reduce the weight of fly ash to be treated, and the fly ash to be treated is then subjected to wet specific gravity separation.

In order to enrich cenospheres contained in fly ash, a method can be used in which separation is conducted by utilizing a difference in physical properties between cenosphere particles and non-cenosphere particles. However, no big difference has hitherto been revealed other than the difference in specific gravity. The inventors made studies on the characteristics of cenosphere particles in detail. As a result, the inventors have found that most of cenosphere particles are present in a relatively large particle size range. The inventors made further studies based on this finding. As a result, the inventors have found that, when fly ash is classified in the dry state, of particle matters which are classified into coarse particle matters and fine particle matters, cenospheres are present in an enriched state in coarse particle matters which are a mass of particles with a large particle size.

From the above, in this embodiment, fly ash to be used as a raw material is classified in the dry state, and the coarse particle matters in which cenospheres are present in an enriched state are subjected to wet specific gravity separation. For classifying fly ash in the dry state, either classifying by sieving by using a sieve or dry classification by utilizing the flow of air may be used.

As for the particle size at the time of classification, an optimum value for collecting cenosphere efficiently with a small degree of loss can be set appropriately by collecting a sample from fly ash which is to be used as a raw material, and studying the particle size distribution thereof, the amount ratio of cenospheres or the like for the collected sample. Normally, it is preferred that the particle size be 20 μm or more.

Further, the number of classification of fly ash to be used as a raw material is not limited to once. Classification may be conducted a plurality of times at different particle sizes.

For example, while subjecting coarse particle matters which have been classified at a prescribed particle size (first coarse particle matters) to wet specific gravity separation, the thus classified fine particle matters (first fine particle matters) are classified at a further small particle size. The resulting second coarse fine particles may be subjected to wet specific gravity separation. More specifically, the first fine particle matters which are obtained by classifying fly ash as a raw material preferably at a particle size of 20 μm or more are further classified preferably at a particle size of 5 to 20 μm. The resulting second coarse particle matters are subjected to wet specific gravity separation, and cenospheres can be produced from both the first coarse particle matters and the second coarse particle matters.

In either case, cenospheres are present in an enriched state in the classified coarse particle matters. The amount to be subjected to wet specific gravity separation is significantly reduced relative to the weight of a raw material. Therefore, high-added-value cenospheres can be produced efficiently while effectively avoiding an increase in size of an apparatus and an increase in energy required for dehydration and drying.

In addition, fly ash is classified into JIS Type-I to JIS Type IV fly ash according to the particle size or the amount of uncombusted matters (JIS [Japanese Industrial Standards] A6201). Any type of fly ash can be used as a raw material. Fly ash which is collected as an industrial waste from a coal-fired power plant or the like can be used as a raw material. As a result of the studies made by the inventors, it is preferable to use JIS Type-IV fly ash which has a large average particle size and a large amount ratio of low-specific-gravity hollow particles.

When JIS Type-IV fly ash is used as a raw material, there is a possibility that fine particle matters which have been classified may be used as they are as JIS Type-I fly ash which is highly useful as a cement admixture or the like.

In subjecting coarse particle matters in which cenospheres are collected by classification to wet specific gravity separation, the coarse particle matters (fly ash) are preferably mixed with water of which the weight is 5 to 10 times higher than the weight of the coarse particle matters, followed by stirring, whereby slurry is formed. It is possible to use a liquid with a prescribed density other than water.

Moreover, in order to allow fly ash to be dispersed satisfactorily in the slurry, it is possible to irradiate the slurry with an ultrasonic wave, or appropriately mix a dispersant which improves the hydrophilicity on the fly ash surface.

When slurry is formed and fly ash is sufficiently dispersed in a liquid such as water, the slurry is allowed to stand for a prescribed period of time. Then, low-specific-gravity components (cenosphere particles) which have come up to the water surface are collected. Then, dehydration is performed by an appropriate method such as dehydration by filtering, dehydration by centrifugation or the like. Thereafter, drying is performed by a heat treatment, whereby cenospheres as a final product are produced.

The type of an apparatus with which wet specific gravity separation is performed is not particularly restricted. However, it is possible to use a thickener with skimming functions, liquid cyclones, multi-gravity separators or the like.

### EXAMPLES

The invention will be explained in more detail with reference to specific examples.

### Example 1

100 g of fly ash A as a raw material were classified by sieving into first coarse particle matters (particle size: 45 μm or more) and first fine particle matters at a particle size of 45 μm by means of a vibrating sieve-type sieving classifier (Sieve shaker, manufactured by RESCH). Further, the first fine particle matters were similarly classified by sieving at a particle size of 20 μm, whereby the first fine particle matters were classified into second coarse particle matters (particle size: 20 to 45 μm) and the second fine particle matters (particle size: 20 μm or less). These particle matters were weighed and the amount ratio of collected particle matters (wt %) relative to the raw material weight was obtained. The results obtained are shown in Table 1.

TABLE 1

| | | Amount ratio of | Yield of |
|---|---|---|---|
| | | collected particles | cenospheres |
| | Particle size | (wt %) | (wt %) |
| Example 1 | 45 μm or more | 11.1 | 0.38 |
| | 20 to 45 μm | 29.3 | 0.20 |
| | 20 μm or less | 59.6 | 0.06 |
| Com. Example 1 | — | — | 0.64 |

Subsequently, each particle matters were mixed with water at a weight ratio of 1:9, followed by stirring, to form slurry. The slurry was allowed to stand for 4 hours. Then, low-specific-gravity components (cenosphere particles) which came up to the water surface were collected. After dehydration by filtration, the components were dried for one hour in an electric furnace at 107° C. (normal pressure, air atmosphere). The dried cenosphere particles were weighed, and the yield of cenospheres relative to the weight of a raw material before sieving was obtained, and the results are shown in Table 1.

### Comparative Example 1

100 g of fly ash A was mixed with water at a weight ratio of 1:9, followed by stirring, without classification to form slurry. Thereafter, as in Example 1, the slurry was subjected to wet specific gravity separation. The dried cenosphere particles were weighed, and the yield of cenospheres relative to the weight of a raw material was obtained, and the results are shown in Table 1.

As mentioned above, the first coarse particle matters with a particle size of 45 μm or more in Example 1 were reduced in weight to 11.1 wt % relative to 100 g of fly ash A as a raw material. From these first coarse particle matters, cenospheres were obtained in an amount of 0.38 wt % relative to the weight of the raw material. This is the amount corresponding to about 60% (0.64 wt % of the raw material weight) of the total amount of the cenospheres obtained in Example 1.

The second coarse particle matters with a particle size of 20 to 45 μm in Example 1 were reduced in weight to 29.3 wt % relative to 100 g of fly ash A as a raw material. From these second coarse particle matters, cenospheres were obtained in an amount of 0.20 wt % relative to the weight of the raw material. The total amount of the cenospheres obtained from the first coarse particle matters and the cenospheres obtained from the second coarse particle matters was 0.58 wt % of the raw material weight. This was the amount corresponding to the yield obtained in Comparative Example 1 where the entire amount (100 g) of fly ash A was subjected to wet specific gravity separation.

In this way, it was revealed that, in Example 1, cenospheres could be produced at a high efficiency from the first coarse particle matters and the second coarse particle matters which were significantly reduced in weight and that cenospheres could be mass-produced at a high efficiency with a small degree of loss even if the production scale was extended.

### Example 2

15 kg of fly ash B as a raw material was classified into first coarse particle matters (particle size: 20 μm or more) and first fine particle matters (particle size: 20 μm or less) by using a dry classifier (Micron Separator MS-1H, manufactured by Hosokawa Micron Corporation) at a particle size of 20 μm. The first fine particle matters were further classified similarly at a particle size of 5 μm, whereby the first fine particles were classified into the second coarse particles (particle size: 5 to 20 μm) and the second fine particles (particle size: 5 μm or less). These particle matters were weighed and the amount ratio of collected particle matters relative to the raw material weight (wt %) was obtained. The results are shown in Table 2.

TABLE 2

| | | Amount ratio of | Yield of |
|---|---|---|---|
| | | collected particles | cenospheres |
| | Particle size | (wt %) | (wt %) |
| Example 2 | 20 μm or more | 12.2 | 0.21 |
| | 5 to 20 μm | 45.4 | 0.06 |
| | 5 μm or less | 42.4 | 0.02 |
| Com. Example 2 | — | — | 0.28 |

Then, cenospheres were collected in the same manner as in Example 1, followed by dehydration and drying. The dried cenosphere particles were weighed, and the yield of cenospheres relative to the raw material weight before classification was obtained, and the results are shown in Table 2.

### Comparative Example 2

100 g of fly ash B was mixed with water at a weight ratio of 1:9 without classification, followed by stirring, to form slurry. Thereafter, as in Example 1, the slurry was subjected to wet specific gravity separation. The dried cenosphere particles were weighed, and the yield of cenospheres relative to the weight of a raw material before sieving was obtained, and the results are shown in Table 2.

As mentioned above, the first coarse particle matters with a particle size of 20 μm or more in Example 2 were reduced in weight to 12.2 wt % relative to 100 g of fly ash B to be used as a raw material. From these first coarse particle matters, cenospheres were obtained in an amount of 0.21 wt % relative to the raw material weight. This was the amount corresponding to about 70% of the total amount of cenospheres (0.29 wt % of the raw material weight) obtained in Example 2.

The second coarse particles with a particle size of 5 to 20 μm in Example 2 were reduced in weight to 45.4 wt % relative to 100 g of fly ash B to be used as a raw material. From these second coarse particle matters, cenospheres were obtained in an amount of 0.06 wt % relative to the raw material weight. The total amount of cenospheres obtained from the first coarse particle matters and the second coarse particle matters was 0.27 wt % of the raw material weight. This was the amount corresponding to the yield obtained in Comparative Example 2 where the entire amount (100 g) of fly ash B was subjected to wet specific gravity separation.

As mentioned above, also as in Example 2, it was confirmed that cenosphere could be produced at a high efficiency from the first coarse particle matters and the second coarse particle matters which were significantly reduced in weight and that cenosphere could be mass-produced at a high efficiency with a small degree of loss even if the production scale was extended.

Here, fly ash A used in Example 1 and Comparative Example 1 was the JIS Type-IV fly ash discharged from a power industrial pulverized coal-fired boiler. Fly ash B used in Example 2 and Comparative Example 2 was fly ash discharged from an industrial pulverized coal-fired boiler.

The invention was explained hereinabove with reference to preferred embodiments. However, it is needless to say that the invention is not limited to the above-mentioned embodiments, and various modifications are possible within the scope of the invention.

### INDUSTRIAL APPLICABILITY

The invention can efficiently produce high-value-added low-specific-gravity hollow particles using coal ash generated when powdered coal is combusted.

1. A method for producing low-specific-gravity-hollow particles comprising:
using, as a raw material, coal ash which is discharged when coal is combusted;
subjecting the coal ash to classification by sieving or dry classification at a prescribed particle size;
subjecting the classified coarse particle matters to wet specific gravity separation to obtain low-specific-gravity components; and
dehydrating and drying the low-specific-gravity components.

2. The method for producing low-specific-gravity hollow particles according to claim 1, wherein the coal ash is fly ash collected from a combustion gas from a pulverized coal-fired boiler.

3. The method for producing low-specific-gravity hollow particles according to claim 1, wherein the coarse particle matters to be subjected to wet specific gravity separation are coarse particle matters which are obtained by subjecting the coal ash to classification by sieving or dry classification at a particle size of 20 μm or more.

4. The method for producing low-specific-gravity hollow particles according to claim 1, wherein said coarse particle matters are second coarse particle matters obtained by further subjecting fine particle matters which are obtained by subjecting said coal ash to classification by sieving or dry classification at a particle size of 20 μm or more to classification by sieving or dry classification at a particle size of 5 to 20 μm.
